(19) United States
(12) Patent Application Publication
(10) Pub. No.: US 2023/0228139 A1
(43) Pub. Date: Jul. 20, 2023

(54) SLIDING DOOR

(71) Applicant: 3I WINDOW AND DOOR LIMIITED, HONG KONG (CN)

(72) Inventors: YAU SING LAI, HONG KONG (CN); YANBIAO XIAO, HONG KONG (CN); SING HUNG LAM, HONG KONG (CN)

(21) Appl. No.: 17/965,733

(22) Filed: Oct. 13, 2022

(30) Foreign Application Priority Data
Jan. 19, 2022 (CN) 202220144368.5
Mar. 23, 2022 (CN) 202220650291.9

(51) Int. Cl. E05D 15/36

(52) U.S. Cl. CPC E05D 15/36; E05Y 2201/684; E05Y 2201/692; E05Y 2800/205; E05Y 2800/74; E05Y 2900/132

(57) ABSTRACT

The present application discloses a sliding door comprising a door body, a supporting structure, a guiding structure, a lower sliding rail module and an upper sliding rail module, the supporting structure and the guiding structure are respectively fixed with the door body; the lower sliding rail module comprises first and second lower sliding rails; the upper sliding rail module comprises first and second upper sliding rails; when the door body, the first upper sliding rail and the first lower sliding rail are on the same plane, the door body is in a closed state, and when the door body, the second upper sliding rail and the second lower sliding rail are on the same plane, the door body is in an open state. Thus, the present application enables the door body to not occupy the width of the doorway in the open state.

### CROSS-REFERENCE TO RELATED APPLICATIONS

The present application claims priority to Chinese Patent Application No. 202220144368.5, filed with the Chinese Patent Office on Jan. 19, 2022, titled “A SLIDING DOOR” and Chinese Patent Application No. 202220650291.9, filed with the Chinese Patent Office on Mar. 23, 2022, titled “A SLIDING DOOR”, the entire contents of which are incorporated herein by reference.

### TECHNICAL FIELD

The present application relates to the technical field of doors and windows, and in particular, relates to a sliding door.

### BACKGROUND

Sliding doors are widely used in various places, especially in some places with small space, because they feature simple and beautiful design and do not occupy indoor space when they are opened or closed. If swinging doors are used, a fan-shaped area needs to be reserved as a space for moving the swinging doors when they are opened or closed. Therefore, in places with small space, such as balconies, sliding doors are the first choice of people.

During the implementation of the present application, the applicant found that the traditional sliding door can only open half the width of the doorway, and in places with small space, only half the width of the doorway is very inconvenient for people to go in and out.

### SUMMARY

A main technical problem to be solved by the present application is to provide a sliding door, which can overcome the above problems or at least partially solve the above problems.

To solve the above technical problems, a technical solution adopted in the present application is to provide a sliding door which comprises a door body, a supporting structure, a guiding structure, a lower sliding rail module and an upper sliding rail module, wherein one end of the supporting structure is fixed on a first surface of the door body; one end of the guiding structure is fixed on a second surface of the door body, the first surface of the door body is opposite to the second surface of the door body; the lower sliding rail module comprises a first lower sliding rail and a second lower sliding rail, the first lower sliding rail is connected with the second lower sliding rail, and the first lower sliding rail is perpendicular to the second lower sliding rail, the other end of the supporting structure is arranged on the lower sliding rail module, and the supporting structure is moveable along the lower sliding rail module; the upper sliding rail module comprises a first upper sliding rail and a second upper sliding rail, the first upper sliding rail is connected with the second upper sliding rail, the first upper sliding rail is parallel to the first lower sliding rail, the second upper sliding rail is parallel to the second lower sliding rail, the other end of the guiding structure is arranged on the upper sliding rail module, and the other end of the guiding structure is moveable along the upper sliding rail module; when the door body, the first upper sliding rail and the first lower sliding rail are on the same plane, the door body is in a closed state, and when the door body, the second upper sliding rail and the second lower sliding rail are on the same plane, the door body is in an open state.

Preferably, the guiding structure comprises a hanging wheel frame and a hanging wheel, wherein the hanging wheel frame is fixed on the first surface of the door body, and the hanging wheel is rotatably arranged on the hanging wheel frame.

Preferably, the upper sliding rail module comprises a first guiding groove and a first clamping platform assembly, the opening of the first guiding groove faces the first surface of the door body; the hanging wheel comprises a first pulley which is accommodated in the first guiding groove, the diameter of the first pulley is smaller than the vertical distance between a first side wall and a second side wall of the first guiding groove, the first side wall and the second side wall of the first guiding groove are oppositely arranged; the first clamping platform assembly is arranged on the inner wall of the first guiding groove, and the first clamping platform assembly is used for preventing the hanging wheel from being separated from the first guiding groove.

Preferably, the hanging wheel further comprises a second pulley which is accommodated in the first guiding groove, and the diameter of the second pulley is smaller than the vertical distance between the first side wall and the second side wall of the first guiding groove.

Preferably, the first clamping platform assembly comprises a first clamping platform and a second clamping platform; the first clamping platform is arranged on the first side wall of the first guiding groove, a first surface of the first clamping platform abuts against the first pulley, and the first surface of the first clamping platform is a first inclined plane; the second clamping platform is arranged on the second side wall of the first guiding groove, a first surface of the second clamping platform abuts against the second pulley, and the first surface of the second clamping platform is a second inclined plane.

Preferably, the supporting structure comprises a first supporting frame and a universal wheel, one end of the first supporting frame is fixed on the second surface of the door body, the universal wheel is rotatably arranged at the other end of the first supporting frame; the surface of the lower sliding rail module facing the second surface of the door body is provided with a bearing groove; the other end of the first supporting frame is provided with an accommodating groove which extends from the other end of the first supporting frame to one end of the first supporting frame, a part of the universal wheel is accommodated in the accommodating groove, the other part of the universal wheel away from the first supporting frame is accommodated in the bearing groove, and the universal wheel is moveable along the bearing groove.

Preferably, the first supporting frame comprises a fixed frame, an elastic component and a connector; one end of the fixed frame is fixed on the second surface of the door body, one end of the elastic component abuts against the other end of the fixed frame, the other end of the elastic component abuts against one end of the connector, and the accommodating groove is arranged at the other end of the connector.

Preferably, the lower sliding rail module further comprises a drainage channel which is arranged at one side of the lower sliding rail module away from the door body, one end of the drainage channel is in communication with the bearing groove, and the other end of the drainage channel is in communication with the first surface of the lower sliding rail module.

Preferably, the upper sliding rail module is provided with a second guiding groove; the guiding structure comprises a fixing component and a guiding component, wherein one end of the fixing component is fixed on the second surface of the door body, the other end of the fixing component extends in the direction away from a third surface of the door body, the third surface of the door body is perpendicular to both the first surface of the door body and the second surface of the door body, one end of the guiding component is arranged at the other end of the fixing component, the other end of the guiding component is accommodated in the second guiding groove, and the other end of the guiding component is movable along the second guiding groove.

Preferably, the other end of the fixing component is provided with a through hole, which penetrates from a first surface of the fixing component to a second surface of the fixing component, the first surface of the fixing component is parallel to the first surface of the door body; the guiding component comprises a guiding rod, a roller and a first screw connector, wherein the guiding rod is provided with external threads and a first boss, the threads are arranged at one end of the guiding rod, one end of the guiding rod passes through the through hole and then is screwed with the first screw connector, the other end of the guiding rod is accommodated in the second guiding groove, the roller is sleeved on the guiding rod, one end of the roller abuts against the first boss, the other end of the roller abuts against the first surface of the fixing component, the roller is partially accommodated in the second guiding groove, and the roller is movable along the second guiding groove.

Preferably, the roller comprises an abutting piece and a rolling piece, wherein the abutting piece is sleeved on the guiding rod, one end of the abutting piece abuts against the first boss, the other end of the abutting piece abuts against the first surface of the fixing component, the rolling piece is sleeved on the abutting piece, the length of the rolling piece is smaller than that of the abutting piece along a first direction, the rolling piece is rotatable around the abutting piece, and the first direction is perpendicular to the first surface of the fixing component.

Preferably, the guiding component further comprises a limiting wheel, a limiting rod and a sleeve, the other end of the guiding rod is provided with a screw groove; one end of the limiting rod is provided with external threads, one end of the limiting rod is screwed into the screw groove, the other end of the limiting rod is provided with a second boss, both the limiting wheel and the sleeve are sleeved at the other end of the limiting rod, and the limiting wheel and the sleeve are positioned between the second boss and the roller, one end of the limiting wheel away from the roller abuts against the second boss, the other end of the limiting wheel close to the roller abuts against one end of the sleeve, and the other end of the roller abuts against the first boss.

Preferably, the limiting wheel comprises an abutting wheel and a rotating wheel, wherein the abutting wheel is sleeved at the other end of the limiting rod, one end of the abutting wheel away from the roller abuts against the second boss, the other end of the abutting wheel close to the roller abuts against one end of the sleeve, and the rotating wheel is rotatably arranged on the abutting wheel.

Preferably, the supporting structure comprises a second supporting frame and a supporting wheel, wherein the second supporting frame is arranged on the first surface of the door body, the supporting wheel is rotatably arranged on the second supporting frame; the lower sliding rail module is provided with a second sliding groove and a second clamping platform assembly, the second clamping platform assembly is arranged on the inner wall of the second sliding groove, the supporting wheel is accommodated in the second sliding groove, and the supporting wheel is moveable along the second sliding groove; the supporting wheel comprises a third pulley which is accommodated in the second sliding groove, the diameter of the third pulley is smaller than the vertical distance between a first side wall and a second side wall of the second sliding groove, the first side wall and the second side wall of the second sliding groove are oppositely arranged, and the second clamping platform assembly is used for supporting the supporting wheel.

Preferably, the supporting wheel further comprises a fourth pulley which is accommodated in the second sliding groove, the diameter of the fourth pulley is smaller than the vertical distance between the first side wall and the second side wall of the second sliding groove; the second clamping platform assembly comprises a third clamping platform and a fourth clamping platform; the third clamping platform is arranged on the first side wall of the second sliding groove, a first surface of the third clamping platform abuts against the third pulley, and the first surface of the third clamping platform is a third inclined plane; the fourth clamping platform is arranged on the second side wall of the second sliding groove, a first surface of the fourth clamping platform abuts against the fourth pulley, and the first surface of the fourth clamping platform is a fourth inclined plane.

The present application has the following beneficial effects: different from the situation in the prior art, in the present application, the sliding door moves along the lower sliding rail module through the arrangement of the supporting structure and the lower sliding rail module, and meanwhile, the door body is always kept in a vertical state through the arrangement of the guiding structure and the upper sliding rail module, and the first lower sliding rail is perpendicular to the second lower sliding rail of the lower sliding rail module, the first upper sliding rail is parallel to the first lower sliding rail, and the second upper sliding rail is parallel to the second lower sliding rail. In this way, when the door body, the first upper sliding rail and the first lower sliding rail are on the same plane, the door body is in a closed state; when the door body, the second upper sliding rail and the second lower sliding rail are on the same plane, the door body is in an open state; and when the door body is in the open state, the door body does not occupy the width of the doorway so that the space at the doorway allowing people to go in and out can be increased.

### BRIEF DESCRIPTION OF THE DRAWINGS

In order to explain specific embodiments of the present application or technical solutions in the prior art more clearly, attached drawings required in the description of the specific embodiments or the prior art will be briefly introduced hereinafter. In all the attached drawings, similar elements or parts are generally labeled by similar reference numerals. In the attached drawings, elements or parts are not necessarily drawn to actual scale.

FIG. 1 is a front view of a sliding door in a first embodiment of the present application.

FIG. 2 is a left view of the sliding door in the first embodiment of the present application.

FIG. 3 is a top view of the sliding door in the first embodiment of the present application.

FIG. 4 is an enlarged view of a part D1 in the left view of the sliding door in the first embodiment of the present application.

FIG. 5 is an enlarged view of a part D1A in the front view of the sliding door in the first embodiment of the present application.

FIG. 6 is an enlarged view of a part D2 in the left view of the sliding door in the first embodiment of the present application.

FIG. 7 is an enlarged view of a part D2A in the front view of the sliding door in the first embodiment of the present application.

FIG. 8 is an enlarged view of a part D3 in the front view of the sliding door in the first embodiment of the present application.

FIG. 9 is an enlarged view of a part D4 in the front view of the sliding door in the first embodiment of the present application.

FIG. 10 is a cross-sectional view taken along A-A in the left view of the sliding door in the first embodiment of the present application.

FIG. 11 is a cross-sectional view taken along B-B in the left view of the sliding door in the first embodiment of the present application.

FIG. 12 is a schematic structural diagram of a connector and a universal wheel of a supporting wheel component in the first embodiment of the present application.

FIG. 13 is a schematic view of the movement trajectory of the door body in the first embodiment of the present application.

FIG. 14 is a front view of the sliding door when the number of door body is two in the first embodiment of the present application.

FIG. 15 is a top view of the sliding door when the number of door body is two in the first embodiment of the present application.

FIG. 16 is a front view of the sliding door when the number of door body is three in the first embodiment of the present application.

FIG. 17 is a top view of the sliding door when the number of door body is three in the first embodiment of the present application.

FIG. 18 is a front view of the sliding door in a second embodiment of the present application.

FIG. 19 is a cross-sectional view taken along C-C in FIG. 18.

FIG. 20 is an enlarged view of a portion A1 in FIG. 18.

FIG. 21 is an enlarged view of a portion A2 in FIG. 18.

FIG. 22 is an enlarged view of a portion A3 in FIG. 19.

FIG. 23 is an enlarged view of a portion A4 in FIG. 19.

FIG. 24 is a schematic installation diagram of a guiding structure of the sliding door in the second embodiment of the present application.

FIG. 25 is a cross-sectional view taken along D-D in FIG. 24.

### DETAILED DESCRIPTION

In order to facilitate the understanding of the present application, the present application will be explained in more detail below with reference to attached drawings and specific embodiments. It shall be noted that, when an element is expressed as “fixed to” another element, it may be directly on the another element, or there may be one or more intervening elements therebetween. When one element is expressed as “connected” to another element, it may be directly connected to the another element, or there may be one or more intervening elements therebetween. Orientations or positional relationships indicated by terms such as “upper”, “lower”, “inner”, “outer”, “vertical” and “horizontal” used in this specification are based on the orientations or positional relationships shown in the attached drawings, and this is only for convenience of describing the present application and simplifying the description, and does not indicate or imply that the devices or elements mentioned must have a specific orientation, and must be constructed and operated in a specific orientation, and thus these terms should not be construed as limitation of the present application. In addition, terms “first” and “second” are only used for descriptive purposes, and should not be construed as indicating or implying relative importance.

Unless otherwise defined, all technical and scientific terms used in this specification have the same meanings as commonly understood by those skilled in the art of the present application. The terms used in the specification of the present application is only for the purpose of describing specific embodiments, and are not intended to limit the present application. The term “and/or” used in this specification comprises any and all combinations of one or more of associated listed items.

In addition, the technical features involved in different embodiments of the present application described below can be combined with each other as long as they do not conflict with each other.

### First Embodiment

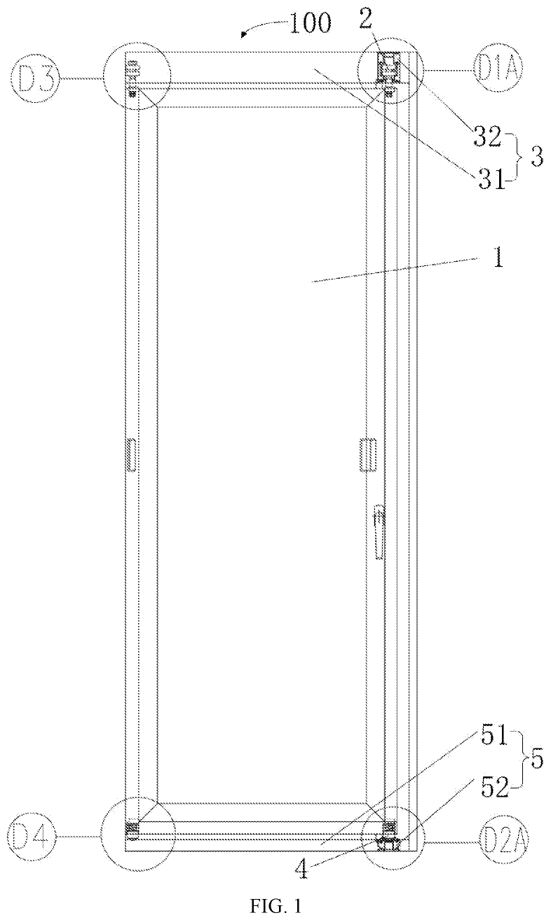

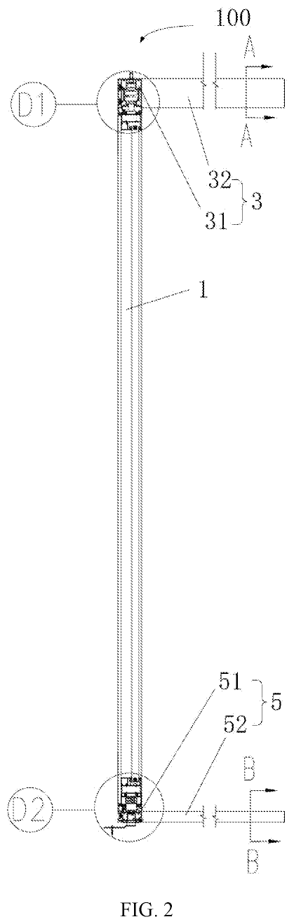

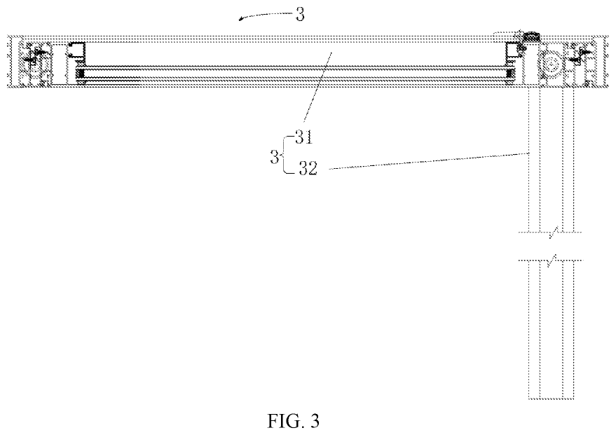

Referring to FIG. 1, FIG. 2 and FIG. 3, a sliding door 100 comprises a door body 1, a guiding structure 2, an upper sliding rail module 3, a supporting structure 4 and a lower sliding rail module 5. One end of the guiding structure 2 is fixed on a first surface of the door body 1, the other end of the guiding structure 2 is arranged on the upper sliding rail module 3, and the guiding structure 2 can move along the upper sliding rail module 3. One end of the supporting structure 4 is fixed on the other end of the door body 1, the other end of the supporting structure 4 is arranged on the lower sliding rail module 5, and the supporting structure 4 can move along the lower sliding rail module 5.

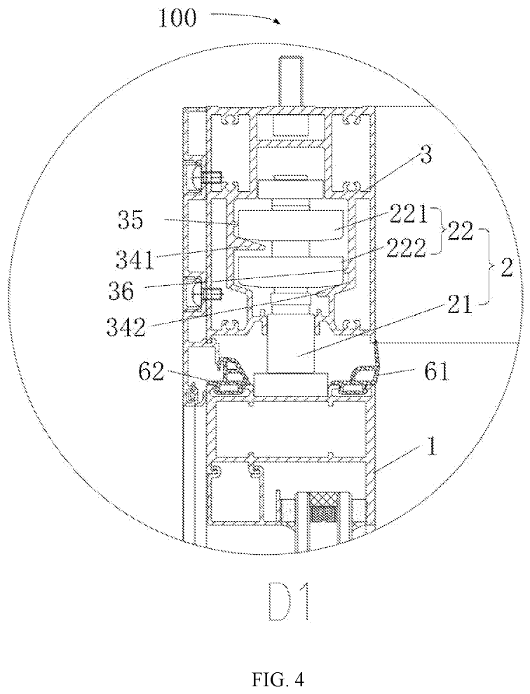

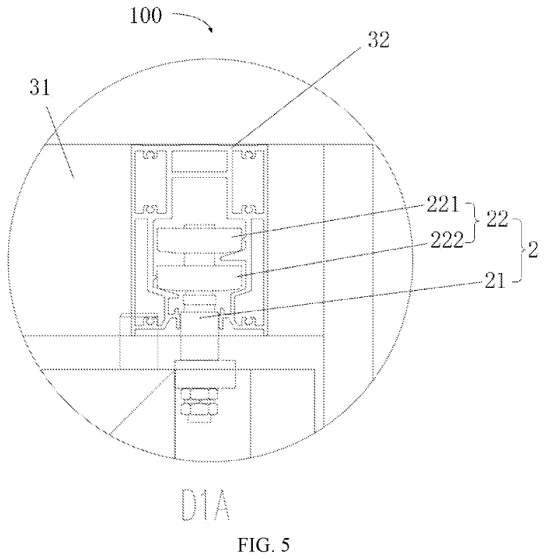

Please refer to FIG. 4 and FIG. 5 for the above-mentioned guiding structure 2, and the guiding structure 2 comprises a hanging wheel frame 21 and a hanging wheel 22. The hanging wheel frame 21 is fixed on the first surface of the door body 1, and the hanging wheel 22 is rotatably arranged on the hanging wheel frame 21.

Please refer to FIG. 4 and FIG. 5 for the above-mentioned hanging wheel 22, the hanging wheel 22 comprises a first pulley 221 and a second pulley 222, the first pulley 221 is rotatably arranged on the hanging wheel frame 21, and the second pulley 222 is rotatably arranged on the hanging wheel frame 21.

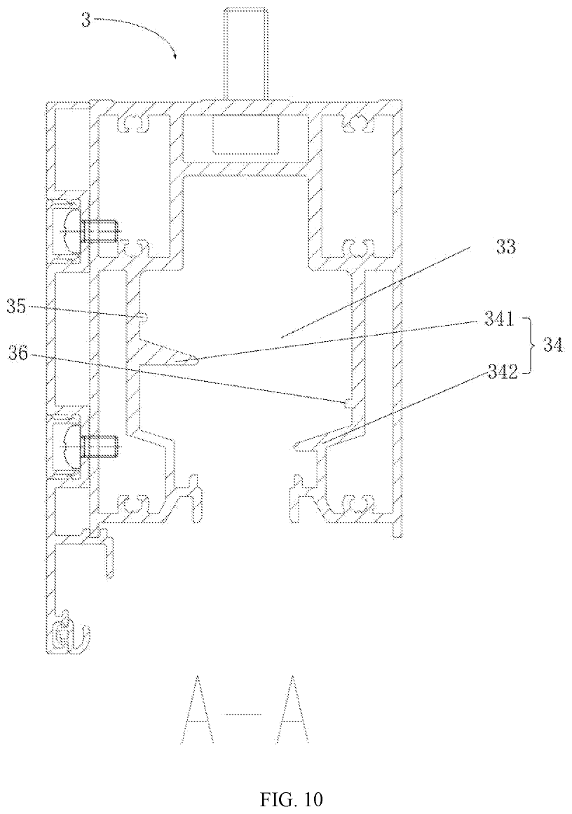

Please refer to FIG. 2, FIG. 4, FIG. 5 and FIG. 10 for the above-mentioned upper sliding rail module 3, the upper sliding rail module 3 comprises a first upper sliding rail 31, a second upper sliding rail 32, a first guiding groove 33, a first clamping platform assembly 34, a first protrusion 35 and a second protrusion 36. One end of the first upper sliding rail 31 is connected with one end of the second upper sliding rail 32, and the first upper sliding rail 31 is perpendicular to the second upper sliding rail 32. The first upper sliding rail 31 is provided with a first groove (not labeled), the second upper sliding rail 32 is provided with a second groove (not labeled), one end of the first groove is connected with one end of the second groove, the first groove and the second groove form the first guiding groove 33, and the opening of the first guiding groove 33 faces the first surface of the door body 1. The first pulley 221 and the second pulley 222 are accommodated in the first guiding groove 33, and the first pulley 221 and the second pulley 222 can move in the first guiding groove 33, the first clamping platform assembly 34 is arranged on the inner wall of the first guiding groove 33, the first clamping platform assembly 34 is used for preventing the first pulley 221 and the second pulley 222 from being separated from the first guiding groove 33. The first protrusion 35 is disposed on the first side wall of the first guiding groove 33, the second protrusion 36 is disposed on the second side wall of the first guiding groove 33, and the first side wall of the first guiding groove 33 and the second side wall of the first guiding groove 33 are oppositely arranged. The distance between one end of the first protrusion 35 away from the first side wall of the first guiding groove 33 and one end of the second protrusion 36 away from the second side wall of the first guiding groove 33 along a first direction is smaller than the sum of the radius of the first pulley 221 and the radius of the second pulley 222, and the first direction is perpendicular to the first side wall of the first guiding groove 33 and the second side wall of the first guiding groove 33. Therefore, When the outer wall of the first pulley 221 abuts against the first protrusion 35, there is a gap between the second pulley 222 and the second protrusion 36, and when the outer wall of the second pulley 222 abuts against the second protrusion 36, there is a gap between the first pulley 221 and the first protrusion 35, thereby preventing the second pulley 222 from abutting against the second protrusion 36 when the first pulley 221 abuts against the first protrusion 35, and achieving the purpose of reducing the friction between the hanging wheel 22 and the first guiding groove 33.

Please refer to FIG. 4 and FIG. 10 for the above-mentioned first clamping platform assembly 34, the first clamping platform assembly 34 comprises a first clamping platform 341 and a second clamping platform 342, the first clamping platform 341 is arranged on the first side wall of the first guiding groove 33, a first surface of the first clamping platform 341 is a first inclined plane, and one end of the first pulley 221 close to the door body abuts against the first inclined plane. The second clamping platform 342 is arranged on the second side wall of the first guiding groove 33, a first surface of the second clamping platform 342 is a second inclined plane, and one end of the second pulley 222 close to the door body abuts against the second inclined plane. By arranging the first inclined plane on the first clamping platform 341 and the second inclined plane on the second clamping platform 342, the contact area between the first clamping platform 341 and the first pulley 221 as well as the contact area between the second clamping platform 342 and the second pulley 222 can be reduced, thereby reducing the friction between the first clamping platform 341 and the first pulley 221 as well as the friction between the second clamping platform 342 and the second pulley 222.

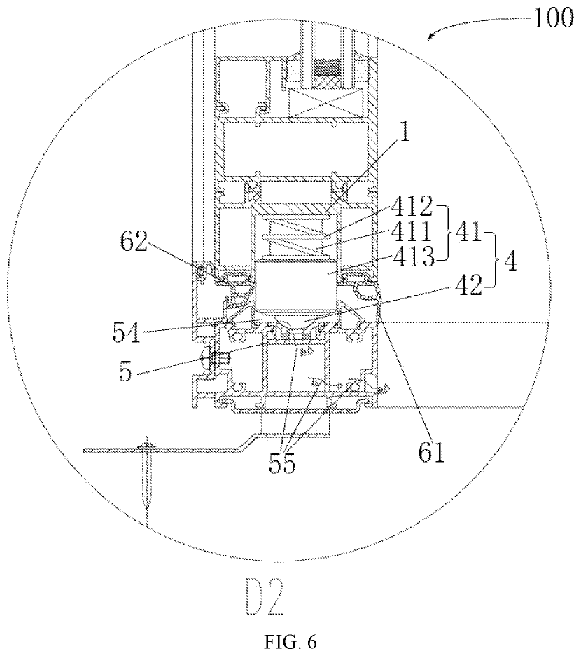

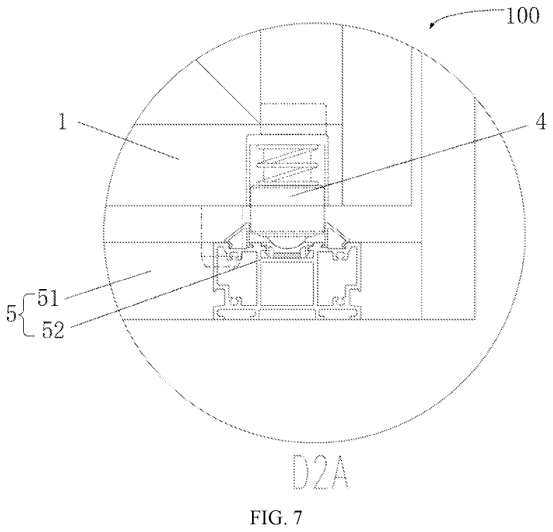

Please refer to FIG. 6 and FIG. 7 for the above-mentioned supporting structure 4, and the supporting structure 4 comprises a first supporting frame 41 and a universal wheel 42. One end of the first supporting frame 41 is fixed on the second surface of the door body 1, and the first surface of the door body 1 and the second surface of the door body 1 are oppositely arranged. The universal wheel 42 is a rolling ball, and the universal wheel 42 is rotatably arranged at the other end of the first supporting frame 41.

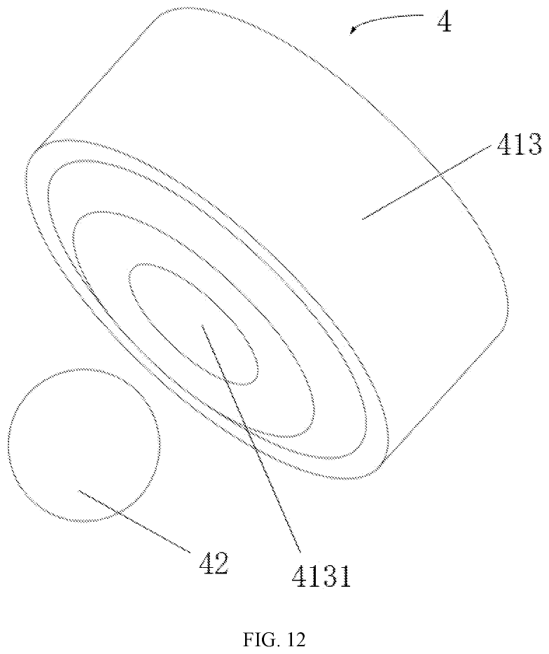

Please refer to FIG. 6 for the above-mentioned first supporting frame 41, the first supporting frame 41 comprises a fixed frame 411, an elastic component 412 and a connector 413. One end of the fixed frame 411 is fixed on the second surface of the door body 1, one end of the elastic component 412 abuts against the other end of the fixed frame 411, the other end of the elastic component 412 abuts against one end of the connector 413, the other end of the connector 413 is provided with an accommodating groove 4131 (as shown in FIG. 12), a part of the universal wheel 42 is accommodated in the accommodating groove 4131, another part of the universal wheel 42 away from the fixed frame 411 abuts against the lower guiding rail module 5, and another part of the universal wheel 42 can roll in the lower guiding rail module 5. The elastic component 412 is used for preventing rigid contact between the universal wheel 42 and the lower sliding rail module 5; and when there are particles in the lower sliding rail module 5, the universal wheel 42 will grind the particles in the lower sliding rail module 5 during rolling. At this time, the universal wheel 42 moves in the direction close to the door body 1, and the elastic component 412 will be compressed and deformed, thereby reducing the wear of the universal wheel 42 and the lower sliding rail module 5.

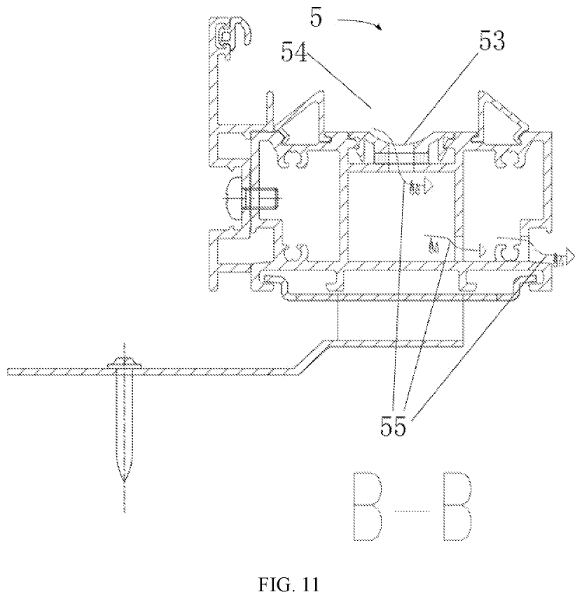

Please refer to FIG. 2, FIG. 6 and FIG. 11 for the above-mentioned lower sliding rail module 5, the lower sliding rail module 5 comprises a first lower sliding rail 51, a second lower sliding rail 52, a bearing groove 53, a first sliding groove 54 and a drainage channel 55. One end of the first lower sliding rail 51 is connected to one end of the second lower sliding rail 52, the first lower sliding rail 51 is perpendicular to the second lower sliding rail 52, and the first lower sliding rail 51 is parallel to the first upper sliding rail 31, and the second lower sliding rail 52 is parallel to the second upper sliding rail 32. The first lower sliding rail 51 is provided with a third groove (not labeled), the second lower sliding rail 52 is provided with a fourth groove (not labeled), one end of the third groove is connected with one end of the fourth groove, the third groove and the fourth groove form the first sliding groove 54, and the opening of the first sliding groove 54 faces the second surface of the door body 1. The bearing groove 53 is arranged at one end of the first sliding groove 54 away from the door body 1, and the inner wall of the bearing groove 53 is an arc surface, another part of the universal wheel 42 abuts against the inner wall of the bearing groove 53, and another part of the universal wheel 42 can roll along the inner wall of the bearing groove 53. One end of the drainage channel 55 is in communication with one side of the first sliding groove 54 away from the door body 1, the other end of the drainage channel 55 is in communication with the first surface of the lower sliding rail module 5; and when there is accumulated water in the first sliding groove 54, the accumulated water will be discharged outside along the drainage channel 55.

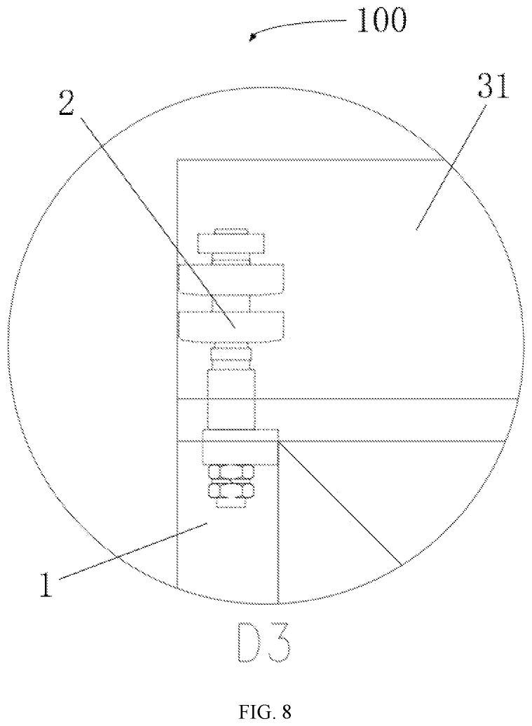

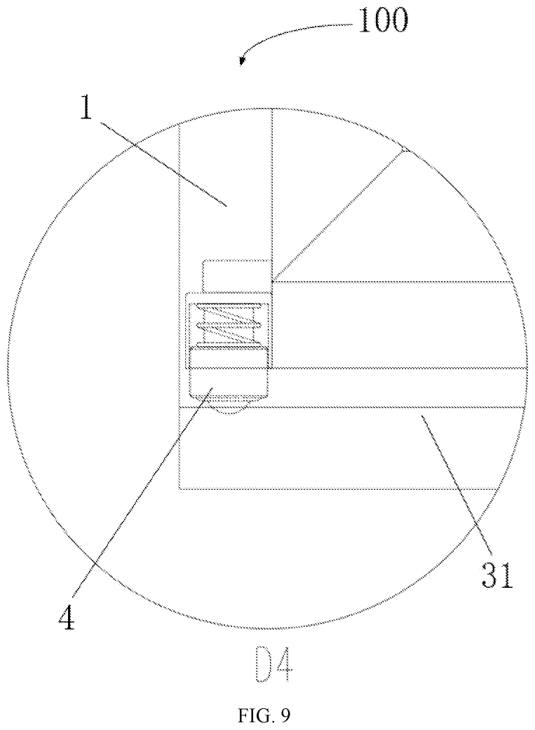

In some embodiments, referring to FIG. 1, FIG. 8 and FIG. 9, the number of the guiding structure 2 is two, and the two guiding structures 2 are respectively fixed on both sides of the first surface of the door body 1. The number of the supporting structure 4 is two, and the two supporting structures 4 are respectively fixed on both sides of the second surface of the door body 1. The use of two guiding structures 2 and two supporting structures 4 can make the door body 1 have good stability when it is opened and closed.

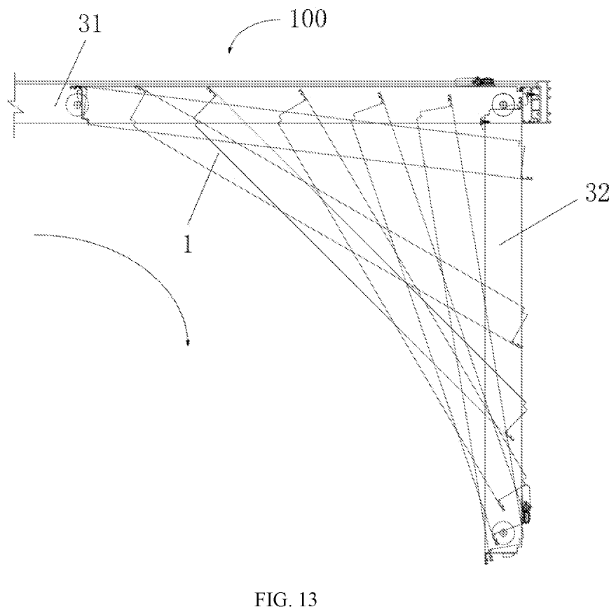

It is worth noting that the guiding structure 2 is fixed on the first surface of the door body 1, the supporting structure 4 is fixed on the second surface of the door body 1, the guiding structure 2 moves along the upper sliding rail module 3, the supporting wheel component 5 can move along the lower sliding rail module 5, and meanwhile, the first lower sliding rail 51 is perpendicular to the second lower sliding rail 52, and the first lower sliding rail 51 is parallel to the first upper sliding rail 31, and the second lower sliding rail 52 is parallel to the second upper sliding rail 32 Thus, when the door body 1 is in the open state, the door body 1 does not occupy the area of the doorway, and the movement trajectory of the door body 1 in the opening process is as shown in FIG. 13.

In some embodiments, referring to FIG. 4 and FIG. 6, the sliding door 100 further comprises a sealing device 6, and the sealing device 6 comprises a first sealing strip 61 and a second sealing strip 62. The first sealing strip 61 is disposed between the door body 1 and the upper sliding rail module 3 at a side near a fourth surface of the door body 1, and between the door body 1 and the lower sliding rail module 5 at a side near the fourth surface of the door body 1. The second sealing strip 62 is arranged between the door body 1 and the upper sliding rail module 3 at a side near a fifth surface of the door body 1, and between the door body 1 and the lower sliding rail module 5 at a side near the fifth surface of the door body 1; the fourth surface of the door body 1 and the fifth surface of the door body 1 are oppositely arranged, and both the fourth surface of the door body 1 and the fifth surface of the door body 1 are perpendicular to the first surface of the door body 1 and the third surface of the door body 1 respectively. The first sealing strip 61 and the second sealing strip 62 make the sliding door 100 have a good sealing effect, and thus, the sliding door 100 is very suitable for places such as balconies that are prone to rain erosion.

In the first embodiment of the present application, the guiding structure 2 is fixed on the first surface of the door body 1, the supporting structure 4 is fixed on the second surface of the door body 1, the guiding structure 2 moves along the upper sliding rail module 3, the supporting wheel component 5 can move along the lower sliding rail module 5, and meanwhile, the first lower sliding rail 51 is perpendicular to the second lower sliding rail 52, and the first lower sliding rail 51 is parallel to the first upper sliding rail 31, and the second lower sliding rail 52 is parallel to the second upper sliding rail 32 so that when the door body 1 is in the open state, the door body 1 will not occupy the area of the doorway.

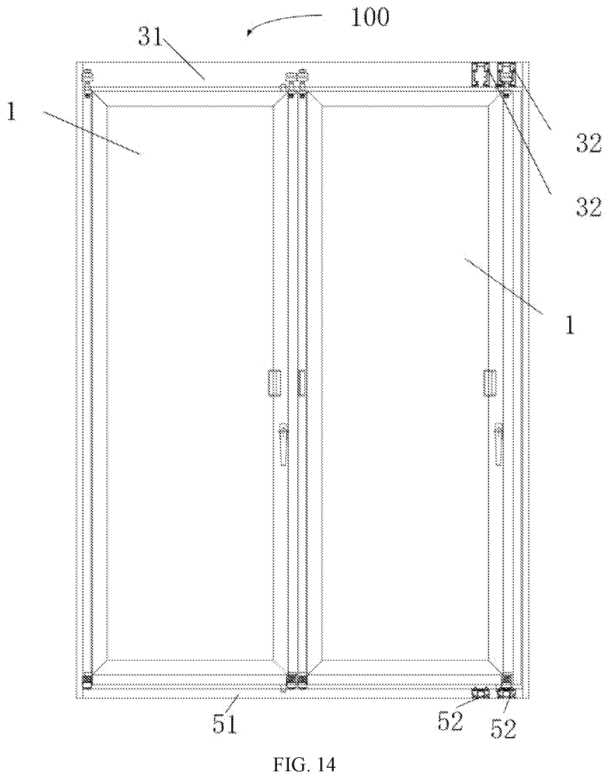

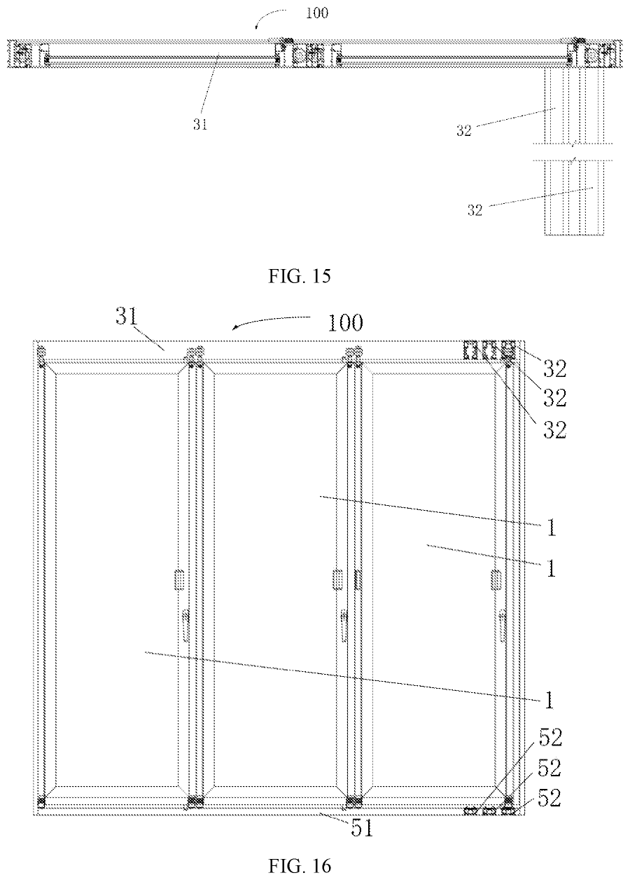

In some embodiments, the number of the door body 1 is two, referring to FIG. 14 and FIG. 15, the number of the second upper sliding rail 32 and the number of the second lower sliding rail 52 are also two correspondingly, the two second upper sliding rails 32 are both arranged at one end of the first upper sliding rail 31, and the two second lower sliding rails 52 are both arranged at one end of the first lower sliding rail 51. In some other embodiments, the two second upper sliding rails 32 may also be respectively arranged at both ends of the first upper sliding rail 31 (not shown), and the two second lower sliding rails 52 may be respectively arranged at both ends of the first lower sliding rail 51 (not shown).

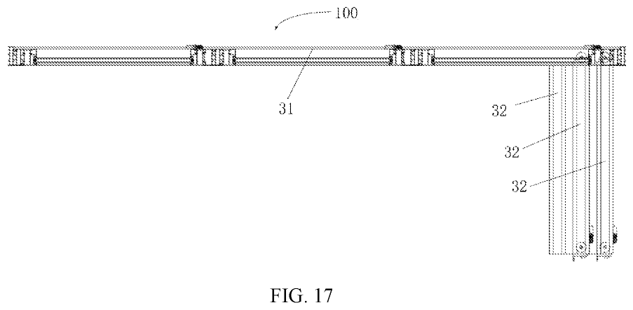

In some embodiments, the number of the door body 1 is three, referring to FIG. 16 and FIG. 17, the number of the second upper sliding rail 32 and the number of the second lower sliding rail 52 are also three correspondingly, the three second upper sliding rails 32 are all arranged at one end of the first upper sliding rail 31, and the three second lower sliding rails 52 are all arranged at one end of the first lower sliding rail 51. In some other embodiments, the three second upper sliding rails 32 may also be respectively arranged at both ends of the first upper sliding rail 31 (not shown), and the two second lower sliding rails 52 are respectively arranged at both ends of the first lower sliding rail 51 (not shown). It is worth noting that, the number of the second upper sliding rail 32 arranged at one end of the first upper sliding rail 31 and the number of the second lower sliding rail 52 arranged at one end of the first lower sliding rail 51 are the same.

In some embodiments, the number of the door body 1 is more than three, and correspondingly, the number of the second upper sliding rail 32 and the number of the second lower sliding rail 52 are the same as the number of the door body 1, the plurality of second upper sliding rails 32 are all arranged at one end of the first upper sliding rail 31, and the plurality of second lower sliding rails 52 are all arranged at one end of the first lower sliding rail 5.

In some other embodiments, the plurality of second upper sliding rails 32 may also be arranged at both ends of the first upper sliding rail 31, and meanwhile, the plurality of second lower sliding rails 52 are respectively arranged at both ends of the first lower sliding rail 51, and the number of the second upper sliding rail 32 arranged at one end of the first upper sliding rail 31 is the same as that of the second lower sliding rail 52 arranged at one end of the first lower sliding rail 51.

### Second Embodiment

This embodiment differs from other embodiments in arrangement of a guiding structure 2′, an upper sliding rail module 3′, a supporting structure 4′ and a lower sliding rail module 5′.

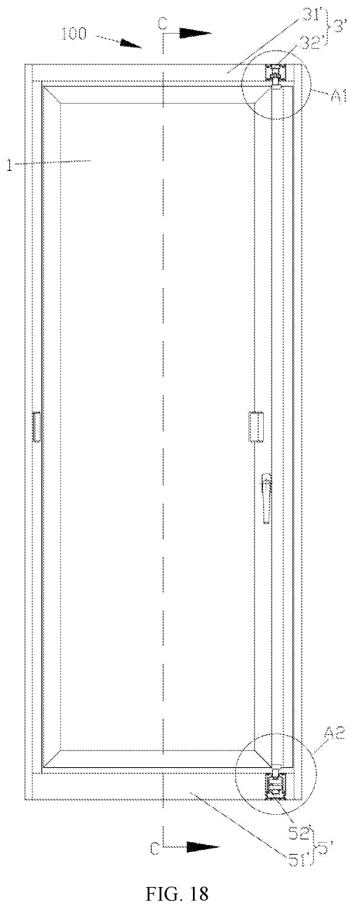

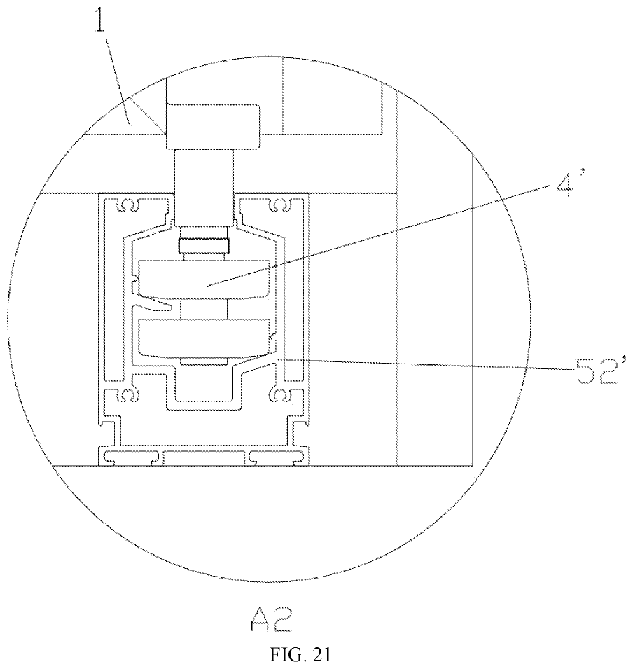

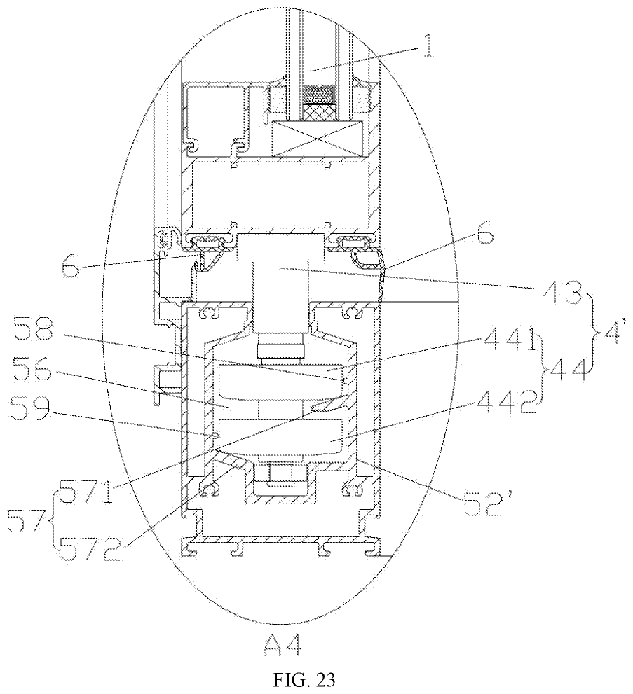

Please refer to FIG. 18, FIG. 21 and FIG. 23 for the above-mentioned supporting structure 4′, the supporting structure 4′ comprises a second supporting frame 43 and a supporting wheel 44, one end of the second supporting frame 43 is fixed on the first surface of the door body 1, the supporting wheel 44 is rotatably arranged at the other end of the second supporting frame 43, and the supporting wheel 44 can move along the lower sliding rail module 5.

Please refer to FIG. 23 for the above-mentioned supporting wheel 44, the supporting wheel 44 comprises a third pulley 441 and a fourth pulley 442, both the third pulley 441 and the fourth pulley 442 are arranged at the other end of the second supporting frame 43, and both the third pulley 441 and the fourth pulley 442 can rotate around the second supporting frame 43.

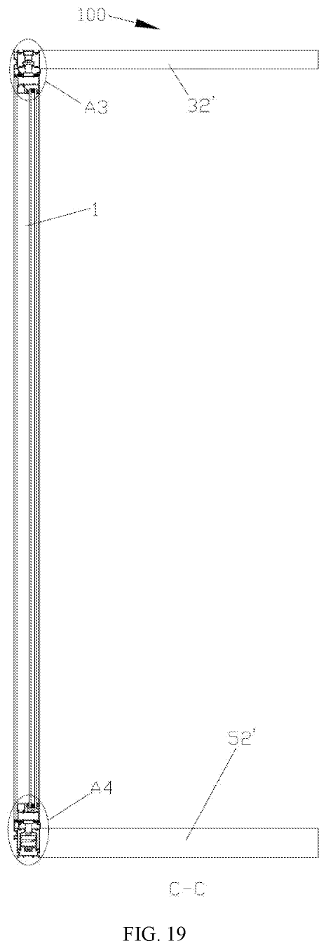

Please refer to FIG. 18, FIG. 19 and FIG. 23 for the above-mentioned lower sliding rail module 5′, the lower sliding rail module 5′ comprises a first lower sliding rail 51′, a second lower sliding rail 52′, a second sliding groove 56, a second clamping platform assembly 57, a third protrusion 58 and a fourth protrusion 59. The first lower sliding rail 51′ is connected with the second lower sliding rail 52′, and the first lower sliding rail 51′ is perpendicular to the second lower sliding rail 52′. The first lower sliding rail 51′ is provided with a fifth groove (not labeled), the second lower sliding rail 52′ is provided with a sixth groove (not labeled), one end of the fifth groove is connected with one end of the sixth groove, the fifth groove and the sixth groove form the second sliding groove 56, and the opening of the second sliding groove 56 faces the first surface of the door body 1. The third pulley 441 and the fourth pulley 442 are accommodated in the second sliding groove 56, and the third pulley 441 and the fourth pulley 442 can move in the second sliding groove 56, the second clamping platform assembly 57 is arranged on the inner wall of the second sliding groove 56, and the second clamping platform assembly 57 is used for bearing the third pulley 441 and the fourth pulley 442. The third protrusion 58 is disposed on the first side wall of the second sliding groove 56, the fourth protrusion 59 is disposed on the second side wall of the second sliding groove 56, and the first side wall of the second sliding groove 56 and the second side wall of the second sliding groove 56 are oppositely arranged. The distance between one end of the third protrusion 58 away from the first side wall of the second sliding groove 56 and one end of the fourth protrusion 59 away from the second side wall of the second sliding groove 56 along the first direction is smaller than the sum of the radius of the third pulley 441 and the radius of the fourth pulley 442, and the first direction is perpendicular to the first side wall of the second sliding groove 56 and the second side wall of the second sliding groove 56. Therefore, When the outer wall of the third pulley 441 abuts against the third protrusion 58, there is a gap between the fourth pulley 442 and the fourth protrusion 59; and when the outer wall of the fourth pulley 442 abuts against the fourth protrusion 59, there is a gap between the third pulley 441 and the third protrusion 58; in this way, the fourth pulley 442 is prevented from abutting against the fourth protrusion 59 when the third pulley 441 abuts against the third protrusion 58, thereby achieving the purpose of reducing the friction between the supporting wheel 44 and the second sliding groove 56.

Please refer to FIG. 21 and FIG. 23 for the above-mentioned second clamping platform assembly 57, the second clamping platform assembly 57 comprises a third clamping platform 571 and a fourth clamping platform 572, the third clamping platform 571 is arranged on the first side wall of the second sliding groove 56, a first surface of the third clamping platform 571 is a third inclined plane, and one end of the third pulley 441 away from the door body 1 abuts against the third inclined plane. The fourth clamping platform 572 is arranged on the second side wall of the second sliding groove 56, a first surface of the fourth clamping platform 572 is a fourth inclined plane, and one end of the fourth pulley 442 away from the door body 1 abuts against the fourth inclined plane. By arranging the third inclined plane on the third clamping platform 571 and the fourth inclined plane on the fourth clamping platform 572, the contact area between the third clamping platform 571 and the third pulley 441 as well as the contact area between the fourth clamping platform 572 and the fourth pulley 442 can be reduced, thereby reducing the friction between the third clamping platform 571 and the third pulley 441 as well as the friction between the fourth clamping platform 572 and the fourth pulley 442, and further reducing resistance during the process of opening or closing the door body 1 so that the process of opening or closing the door body 1 is smoother.

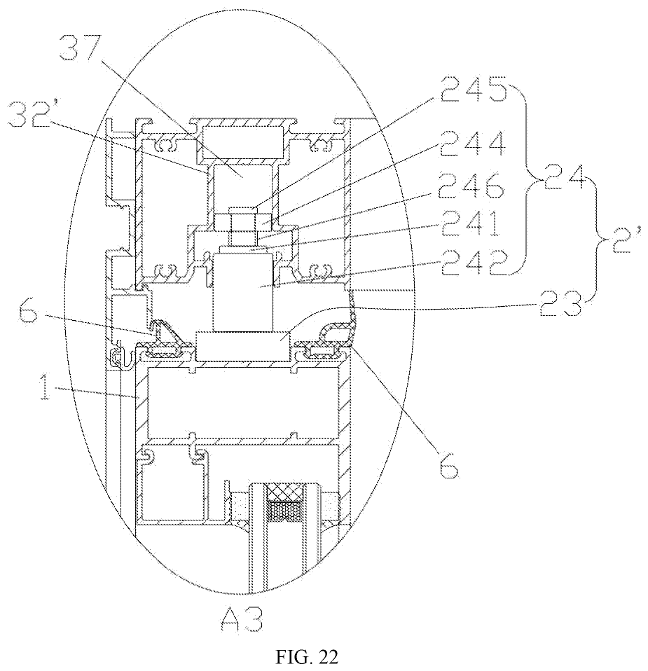

Please refer to FIG. 18, FIG. 19 and FIG. 22 for the above-mentioned upper sliding rail module 3′, and the upper sliding rail module 3′ comprises a first upper sliding rail 31′, a second upper sliding rail 32′ and a second guiding groove 37. The first upper sliding rail 31′ is connected with the second upper sliding rail 32′, the first upper sliding rail 31′ is parallel to the first lower sliding rail 51′, and the second upper sliding rail 32′ is parallel to the second lower sliding rail 52′. The first upper sliding rail 42 is provided with a seventh groove (not labeled), the second upper sliding rail 32′ is provided with an eighth groove (not labeled), the seventh groove and the eighth groove form the second guiding groove 37, the other end of the guiding structure 2 is accommodated in the second guiding groove 37, and the other end of the guiding structure 2 can move along the second guiding groove 37.

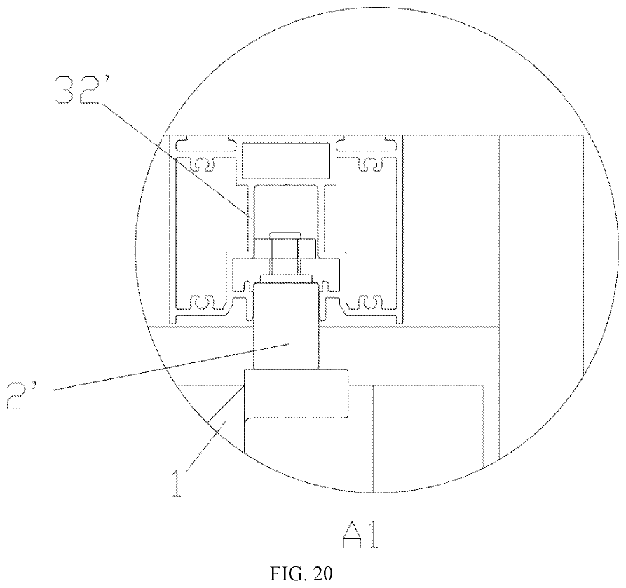

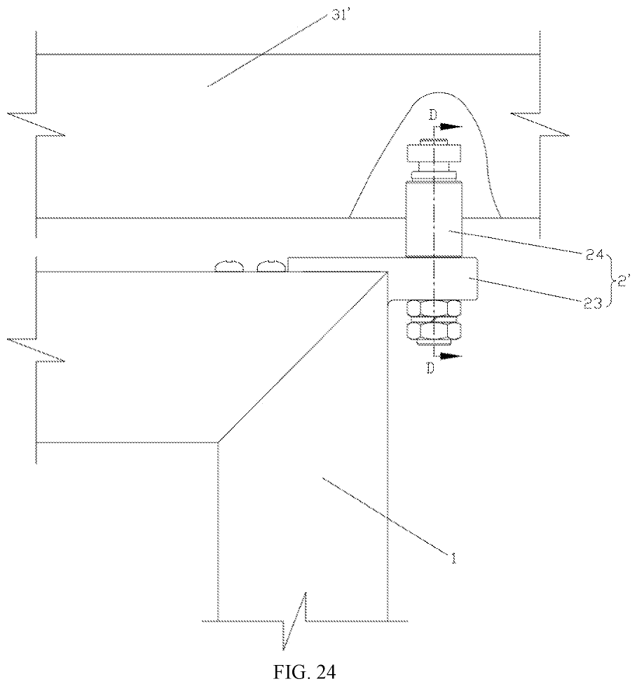

Please refer to FIG. 20, FIG. 22 and FIG. 24 for the above-mentioned guiding structure 2′, and the guiding structure 2′ comprises a fixing component 23 and a guiding component 24. One end of the fixing component 23 is fixed to the second surface of the door body 1, the other end of the fixing component 23 extends in the direction away from the third surface of the door body 1, and the third surface of the door body 1 is perpendicular to both the first surface and the second surface of the door body 1. Another end of the fixing component 23 away from the third surface of the door body 1 is provided with a through hole 231, the through hole 231 penetrates from the first surface of the fixing component 23 to the second surface of the fixing component 23, and the first surface of the fixing component 23 is parallel to the first surface of the door body 1. One end of the guiding component 24 is installed in the through hole 41, and the other end of the guiding component 24 can move along the upper sliding rail module 3.

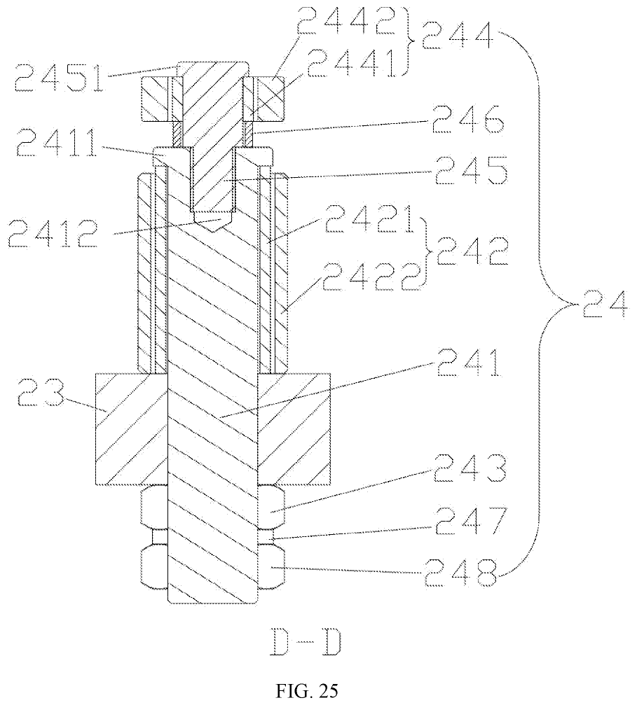

Please refer to FIG. 22, FIG. 24 and FIG. 25 for the above-mentioned guiding component 24, the guiding component 24 comprises a guiding rod 241, a roller 242, a first screw connector 243, a limiting wheel 244, a limiting rod 245, a sleeve 246, a gasket 247 and a second screw connector 248. One end of the guiding rod 241 is provided with first external threads (not labeled), one end of the guiding rod 241 passes through the through hole 231 and then is screwed with the first screw connector 243, the gasket 247 is sleeved on the guiding rod 241, one end of the gasket 247 abuts against one end of the first screw connector 243 away from the second surface of the fixing component 23, the second screw connector 248 is screwed with one end of the guiding rod 241, and the second screw connector 248 abuts against the other end of the gasket 247. The other end of the guiding rod 241 is accommodated in the second guiding groove 37, the roller 242 is sleeved on the guiding rod 241, one end of the roller 242 away from the door body 1 abuts against the guiding rod 241, the other end of the roller 242 near the door body 1 abuts against the first surface of the fixing component 23, the roller 242 is partially accommodated in the second guiding groove 37, and the roller 242 can move along the second guiding groove 37. The limiting rod 245 is installed at the other end of the guiding rod 241, the sleeve 246 is sleeved on the limiting rod 245, one end of the sleeve 246 close to the fixing component 23 abuts against the guiding rod 241, the limiting wheel 244 is sleeved on the limiting rod 245, one end of the limiting wheel 244 close to the fixing component 23 abuts against the other end of the sleeve 246 away from the fixing component 23, the limiting wheel 244 is accommodated in the second guiding groove 37, and the limiting wheel 244 can move along the second guiding groove 37. By screwing both the first screw connector 243 and the second screw connector 248 with one end of the guiding rod 241, and arranging the gasket 247 between the first screw connector 243 and the second screw connector 248, the guiding rod 241 can be more firmly fixed on the fixing component 23.

Please refer to FIG. 25 for the above-mentioned guiding rod 241, the guiding rod 241 is provided with a first boss 2411 and a screw groove 2412, the surface of the first boss 2411 facing the fixing component 23 abuts against one end of the roller 242 away from the door body 1, and the surface of the first boss 2411 facing away from the door body 1 abuts against one end of the sleeve 246 close to the fixing component 23. The screw groove 2412 is arranged at the other end of the guiding rod 241, one end of the limiting rod 245 close to the fixing component 23 is provided with second external threads (not labeled), and one end of the limiting rod 245 is screwed into the screw groove 2412.

Please refer to FIG. 25 for the above-mentioned roller 242, and the roller 242 comprises an abutting piece 2421 and a rolling piece 2422. The abutting piece 2421 is sleeved on the guiding rod 241, one end of the abutting piece 2421 abuts against the surface of the first boss 2411 facing the fixing component 23, the other end of the abutting piece 2421 abuts against the first surface of the fixing component 23, the rolling piece 2422 is sleeved on the abutting piece 2421, the length of the rolling piece 2422 is shorter than the length of the abutting piece 2421 along the first direction, and the first direction is perpendicular to the first surface of the fixing component 23. The rolling piece 2422 can rotate around the abutting piece 2421; when the guiding component 24 moves in the second guiding groove 37, friction often occurs between the guiding component 24 and the side wall of the second guiding groove 37, and the rolling piece 2422 can rotate around the abutting piece 2421, thereby avoiding the sliding friction between the rolling piece 2422 and the second guiding groove 37, and reducing the wear of the side wall of the second guiding groove 37 and the rotating piece 2422.

Please refer to FIG. 25 for the above-mentioned limiting wheel 244, and the limiting wheel 244 comprises an abutting wheel 2441 and a rotating wheel 2442. The abutting wheel 2441 is sleeved on the other end of the limiting rod 245, and the other end of the abutting wheel 2441 close to the roller 242 abuts against one end of the sleeve 246 close to the fixing component 23. The rotating wheel 2442 is rotatably arranged on the abutting wheel 2441 so that the friction between the second guiding groove 37 and the rotating wheel 2442 can be reduced, and the wear of the second guiding groove 37 and the rotating wheel 2442 can be reduced.

Please refer to FIG. 25 for the above-mentioned limiting rod 245, the limiting rod 245 is provided with a second boss 2451, the second boss 2451 is arranged at the other end of the limiting rod 245 away from the fixing component 23, and one end of the abutting wheel 2441 away from the roller 242 abuts against the second boss 2451. The second boss 2451 is arranged at the other end of the limiting rod 245, and then both the sleeve 246 and the limiting wheel 244 are sleeved on the limiting rod 245, and one end of the limiting rod 245 is screwed into the screw groove 2412, so that the limiting wheel 244 can be fixed on the limiting rod 245.

In some embodiments, although not shown, the number of the guiding structure 2 is two, and the two guiding structures 2 are respectively fixed on both sides of the first surface of the door body 1. The number of the supporting structure 4 is two, and the two supporting structures 4 are respectively fixed on both sides of the second surface of the door body 1. The use of two guiding structures 2 and two supporting structures 4 can make the door body 1 have good stability when it is opened and closed.

In the second embodiment of the present application, the door body 1 moves along the second sliding groove 56 through the arrangement of the supporting wheel 44 and the lower sliding rail module 5, and meanwhile, the door body 1 is always perpendicular to the horizontal plane through the arrangement of the guiding structure 2 and the upper sliding rail module 3, and the weight of the door body 1 is only supported by the supporting wheel 44. Therefore, when the door body 1 is installed, the installation accuracy required among the upper sliding rail module 3, the door body 1 and the lower sliding rail module 5 can be reduced, and the installation difficulty can be further reduced.

In the embodiment of the present application, the sliding door 100 moves along the lower sliding rail module 5 through the arrangement of the supporting structure 4 and the lower sliding rail module 5, and meanwhile, the door body 1 is always kept in a vertical state through the arrangement of the guiding structure 2 and the upper sliding rail module 3, and the first lower sliding rail 51 is perpendicular to the second lower sliding rail 52 of the lower sliding rail module 5, the first upper sliding rail 31 is parallel to the first lower sliding rail 51, and the second upper sliding rail 32 is parallel to the second lower sliding rail 52. In this way, when the door body 1, the first upper sliding rail 31 and the first lower sliding rail 51 are on the same plane, the door body 1 is in a closed state; when the door body 1, the second upper sliding rail 32 and the second lower sliding rail 52 are on the same plane, the door body 1 is in an open state; and when the door body 1 is in the open state, the door body 1 does not occupy the width of the doorway so that the space at the doorway allowing people to go in and out can be increased.

What described above are only embodiments of the present application, and are not intended to limit the patent scope of the present application, and any equivalent structure or equivalent process variation made by using the contents of the specification and attached drawings of the present application, or directly or indirectly application in other related technical fields, shall all be equally comprised in the patent scope claimed in the present application.

What is claimed is:

1. A sliding door, being characterized in that, comprising:
a door body;
a supporting structure, one end of which being fixed on a first surface of the door body;
a guiding structure, one end of which being fixed on a second surface of the door body, and the first surface of the door body being opposite to the second surface of the door body;
a lower sliding rail module, comprising a first lower sliding rail and a second lower sliding rail, the first lower sliding rail being connected with the second lower sliding rail, and the first lower sliding rail being perpendicular to the second lower sliding rail, the other end of the supporting structure being arranged on the lower sliding rail module, and the supporting structure being moveable along the lower sliding rail module;
an upper sliding rail module, comprising a first upper sliding rail and a second upper sliding rail, the first upper sliding rail being connected with the second upper sliding rail, the first upper sliding rail being parallel to the first lower sliding rail, the second upper sliding rail being parallel to the second lower sliding rail, the other end of the guiding structure being arranged on the upper sliding rail module, and the other end of the guiding structure being moveable along the upper sliding rail module;
when the door body, the first upper sliding rail and the first lower sliding rail are on the same plane, the door body is in a closed state, and when the door body, the second upper sliding rail and the second lower sliding rail are on the same plane, the door body is in an open state.

2. The sliding door according to claim 1, being characterized in that,
the guiding structure comprises a hanging wheel frame and a hanging wheel, wherein the hanging wheel frame is fixed on the first surface of the door body, and the hanging wheel is rotatably arranged on the hanging wheel frame.

3. The sliding door according to claim 2, being characterized in that,
the upper sliding rail module comprises a first guiding groove and a first clamping platform assembly, the opening of the first guiding groove faces the first surface of the door body;
the hanging wheel comprises a first pulley which is accommodated in the first guiding groove, the diameter of the first pulley is smaller than the vertical distance between a first side wall and a second side wall of the first guiding groove, and the first side wall and the second side wall of the first guiding groove are oppositely arranged;
the first clamping platform assembly is arranged on the inner wall of the first guiding groove, and the first clamping platform assembly is used for preventing the hanging wheel from being separated from the first guiding groove.

4. The sliding door according to claim 3, being characterized in that,
the hanging wheel further comprises a second pulley which is accommodated in the first guiding groove, and the diameter of the second pulley is smaller than the vertical distance between the first side wall and the second side wall of the first guiding groove.

5. The sliding door according to claim 3, being characterized in that,
the first clamping platform assembly comprises a first clamping platform and a second clamping platform;
the first clamping platform is arranged on the first side wall of the first guiding groove, a first surface of the first clamping platform abuts against the first pulley, and the first surface of the first clamping platform is a first inclined plane;
the second clamping platform is arranged on the second side wall of the first guiding groove, a first surface of the second clamping platform abuts against the second pulley, and the first surface of the second clamping platform is a second inclined plane.

6. The sliding door according to claim 1, being characterized in that,
the supporting structure comprises a first supporting frame and a universal wheel, one end of the first supporting frame is fixed on the second surface of the door body, and the universal wheel is rotatably arranged at the other end of the first supporting frame;
the surface of the lower sliding rail module facing the second surface of the door body is provided with a bearing groove;
the other end of the first supporting frame is provided with an accommodating groove which extends from the other end of the first supporting frame to one end of the first supporting frame, a part of the universal wheel is accommodated in the accommodating groove, the other part of the universal wheel away from the first supporting frame is accommodated in the bearing groove, and the universal wheel is moveable along the bearing groove.

7. The sliding door according to claim 6, being characterized in that,
the first supporting frame comprises a fixed frame, an elastic component and a connector;
one end of the fixed frame is fixed on the second surface of the door body, one end of the elastic component abuts against the other end of the fixed frame, the other end of the elastic component abuts against one end of the connector, and the accommodating groove is arranged at the other end of the connector.

8. The sliding door according to claim 7, being characterized in that,
the lower sliding rail module further comprises a drainage channel which is arranged at one side of the lower sliding rail module away from the door body, one end of the drainage channel is in communication with the bearing groove, and the other end of the drainage channel is in communication with the first surface of the lower sliding rail module.

9. The sliding door according to claim 1, being characterized in that,
the upper sliding rail module is provided with a second guiding groove;
the guiding structure comprises a fixing component and a guiding component, wherein one end of the fixing component is fixed on the second surface of the door body, the other end of the fixing component extends in the direction away from a third surface of the door body, the third surface of the door body is perpendicular to both the first surface of the door body and the second surface of the door body, one end of the guiding component is arranged at the other end of the fixing component, the other end of the guiding component is accommodated in the second guiding groove, and the other end of the guiding component is movable along the second guiding groove.

10. The sliding door according to claim 9, being characterized in that,
the other end of the fixing component is provided with a through hole, which penetrates from a first surface of the fixing component to a second surface of the fixing component, and the first surface of the fixing component is parallel to the first surface of the door body;
the guiding component comprises a guiding rod, a roller and a first screw connector, wherein the guiding rod is provided with external threads and a first boss, the threads are arranged at one end of the guiding rod, one end of the guiding rod passes through the through hole and then is screwed with the first screw connector, the other end of the guiding rod is accommodated in the second guiding groove, the roller is sleeved on the guiding rod, one end of the roller abuts against the first boss, the other end of the roller abuts against the first surface of the fixing component, the roller is partially accommodated in the second guiding groove, and the roller is movable along the second guiding groove.

11. The sliding door according to claim 10, being characterized in that,
the roller comprises an abutting piece and a rolling piece, wherein the abutting piece is sleeved on the guiding rod, one end of the abutting piece abuts against the first boss, the other end of the abutting piece abuts against the first surface of the fixing component, the rolling piece is sleeved on the abutting piece, the length of the rolling piece is smaller than that of the abutting piece along a first direction, the rolling piece is rotatable around the abutting piece, and the first direction is perpendicular to the first surface of the fixing component.

12. The sliding door according to claim 10, being characterized in that,
the guiding component further comprises a limiting wheel, a limiting rod and a sleeve, the other end of the guiding rod is provided with a screw groove;
one end of the limiting rod is provided with external threads, one end of the limiting rod is screwed into the screw groove, the other end of the limiting rod is provided with a second boss, both the limiting wheel and the sleeve are sleeved at the other end of the limiting rod, and the limiting wheel and the sleeve are positioned between the second boss and the roller, one end of the limiting wheel away from the roller abuts against the second boss, the other end of the limiting wheel close to the roller abuts against one end of the sleeve, and the other end of the roller abuts against the first boss.

13. The sliding door according to claim 12, being characterized in that,
the limiting wheel comprises an abutting wheel and a rotating wheel, wherein the abutting wheel is sleeved at the other end of the limiting rod, one end of the abutting wheel away from the roller abuts against the second boss, the other end of the abutting wheel close to the roller abuts against one end of the sleeve, and the rotating wheel is rotatably arranged on the abutting wheel.

14. The sliding door according to claim 1, being characterized in that,
the supporting structure comprises a second supporting frame and a supporting wheel, wherein the second supporting frame is arranged on the first surface of the door body, the supporting wheel is rotatably arranged on the second supporting frame;
the lower sliding rail module is provided with a second sliding groove and a second clamping platform assembly, the second clamping platform assembly is arranged on the inner wall of the second sliding groove, the supporting wheel is accommodated in the second sliding groove, and the supporting wheel is moveable along the second sliding groove;
the supporting wheel comprises a third pulley which is accommodated in the second sliding groove, the diameter of the third pulley is smaller than the vertical distance between a first side wall and a second side wall of the second sliding groove, the first side wall and the second side wall of the second sliding groove are oppositely arranged, and the second clamping platform assembly is used for supporting the supporting wheel.

15. The sliding door according to claim 14, being characterized in that,
the supporting wheel further comprises a fourth pulley which is accommodated in the second sliding groove, the diameter of the fourth pulley is smaller than the vertical distance between the first side wall and the second side wall of the second sliding groove;
the second clamping platform assembly comprises a third clamping platform and a fourth clamping platform;
the third clamping platform is arranged on the first side wall of the second sliding groove, a first surface of the third clamping platform abuts against the third pulley, and the first surface of the third clamping platform is a third inclined plane;
the fourth clamping platform is arranged on the second side wall of the second sliding groove, a first surface of the fourth clamping platform abuts against the fourth pulley, and the first surface of the fourth clamping platform is a fourth inclined plane.
